(19) United States
(12) Patent Application Publication
(10) Pub. No.: US 2019/0323290 A1
(43) Pub. Date: Oct. 24, 2019

(54) ARCHITECTURAL-STRUCTURE COVERING HAVING A MOVABLE VALANCE

(71) Applicant: Hunter Douglas, Inc., Pearl River, NY (US)

(72) Inventor: Michael S. Goldberg, Stanley, NC (US)

(73) Assignee: Hunter Douglas, Inc., Pearl River, NY (US)

(21) Appl. No.: 16/380,028

(22) Filed: Apr. 10, 2019

Related U.S. Application Data
(60) Provisional application No. 62/659,237, filed on Apr. 18, 2018.

(51) Int. Cl. E06B 9/323; E06B 9/262; A47H 2/00

(52) U.S. Cl. CPC E06B 9/323; E06B 2009/2625; A47H 2/00; E06B 9/262

(57) ABSTRACT

A mount and associated method for facilitating movement (e.g., pivotable) of a valance relative to a headrail of an architectural-structure covering is disclosed. The device or mount interconnects the valance and the headrail so that the valance can readily move (e.g., pivot) with respect to the headrail. In use, during retraction of the covering, bunching of the covering may cause the covering to contact the valance resulting in the valance moving away from the headrail thus minimizing or eliminating any adverse effects.

### CROSS-REFERENCE TO RELATED APPLICATIONS

This is a non-provisional of, and claims the benefit of the filing date of, pending U.S. provisional patent application No. 62/659,237, filed Apr. 18, 2018, titled “An Architectural-Structure Covering Having a Movable Valance”, the entirety of which application is incorporated by reference herein.

### FIELD OF THE DISCLOSURE

The present disclosure relates generally to architectural-structure coverings, and more particularly to a device and method for movably (e.g., pivotably) coupling a valance to an architectural-structure covering.

### BACKGROUND OF THE DISCLOSURE

Architectural-structure coverings for architectural openings and/or structures (used interchangeably herein without the intent to limit), such as windows, doors, archways, portions of a wall, and the like, have taken numerous forms for many years. One known architectural-structure covering includes a covering such as a fabric that is movable between an extended position and a retracted position. A drive mechanism enables a user to raise and lower the covering between the extended and retracted positions.

Many known architectural-structure coverings include a valance or window top treatment for concealing an upper end of the architectural-structure covering and/or architectural structure. In use, the valance may be manufactured from the same material used for the covering. The valance may provide an improved aesthetic finish by, for example, concealing the mounting hardware required to attach the architectural-structure covering to a wall, etc.

During use of such valances one problem that may be encountered is that the retracted covering can be bulky because it can bunch up when the covering is retracted. For example, in one embodiment, the covering may take the form of a stacked or tiered covering such as, for example, a Roman shade made from an architectural material such as a woven wood (e.g., a covering constructed from a plurality of thin elongated wooden elements arranged and coupled together to form a covering) or the like. In use, the bunching of the covering adjacent to the upper end of the architectural-structure covering can cause the covering to contact the valance at the upper end of the architectural-structure covering, pushing the valance outwards (e.g., causing the valance to bend) away from the architectural-structure covering. It will be appreciated that this may adversely affect the valance and/or covering (e.g., may cause unwanted creases in the covering) and/or aesthetics thereof.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is a mount or system for movably coupling a valance to a headrail of an architectural-structure covering. In use, the mount interconnects a valance and a headrail of an architectural-structure covering so that the valance can move (e.g., pivot) with respect to the headrail. The mount enables the valance to move or pivot away from the headrail. In this manner, as the covering of the architectural-structure covering is retracted, bunching of the covering adjacent to the headrail causes the covering to contact the valance, which in turn causes the valance to move or pivot away from the headrail, thus minimizing or eliminating any resulting adverse effects to the covering, valance, etc.

That is, in use, depending on the type of material being utilized, the covering may become bulky because of bunching when the covering is moved to a retracted position. As a result, the covering may contact the valance positioned at the upper end of the architectural-structure covering, pushing the valance outwards (e.g., causing the valance to bend) away from the architectural-structure covering, which may adversely affect the valance and/or covering (e.g., may cause unwanted creases in the covering) and/or aesthetics thereof. The mount of the present disclosure movably (e.g., pivotably) couples the valance to the headrail so that, in use, the valance can move or pivot with respect to the headrail via contact with the covering when the covering is being moved towards the retracted position. By movably (e.g., pivotably) coupling the valance to the headrail, during retraction of the covering, the valance can move or pivot outwards away from the headrail thus preventing the covering and/or valance from any adverse effects. In use, incorporation of a movable (e.g., pivotable) valance can be particularly beneficial for use with bulky coverings and stiffened valances.

### BRIEF DESCRIPTION OF THE DRAWINGS

FIG. 1 is a perspective view illustrating an example embodiment of an architectural-structure covering including a covering shown in an extended position;

FIG. 2 is a detailed, cross-sectional view taken through an example embodiment of a headrail of an architectural-structure covering, the architectural-structure covering including an example embodiment of a mount in accordance with the present disclosure for coupling a valance to the headrail;

FIG. 3 is a side view of the mount illustrated in FIG. 2;

FIG. 4 is a detailed, cross-sectional view taken through another example embodiment of a headrail of an architectural-structure covering, the architectural-structure covering including a second example embodiment of a mount in accordance with the present disclosure for coupling a valance to the headrail, the mount illustrated in a first (e.g. non-pivoted) position;

FIG. 5 is a detailed, cross-sectional view taken through the headrail shown in FIG. 4, the mount illustrated in a second (e.g. pivoted) position; and

FIG. 6 is a side view of the second example embodiment of a mount illustrated in FIG. 4.

The drawings are not necessarily to scale. The drawings are merely representations, not intended to portray specific parameters of the disclosure. The drawings are intended to depict exemplary embodiments of the disclosure, and therefore are not be considered as limiting in scope. In the drawings, like numbering represents like elements.

### DETAILED DESCRIPTION

Numerous embodiments of a mount or system (used interchangeably herein without the intent to limit) for movably coupling a valance to a headrail of an architectural-structure covering in accordance with the present disclosure will now be described more fully hereinafter with reference to the accompanying drawings, in which embodiments of the present disclosure are presented. In some embodiments, the mount interconnects the valance and the headrail of an architectural-structure covering so that the valance can move (e.g., pivot) with respect to the headrail. The mount of the present disclosure may, however, be embodied in many different forms and should not be construed as being limited to the embodiments set forth herein. Rather, these embodiments are provided so that this disclosure will convey certain example aspects of the mount to those skilled in the art. In the drawings, like numbers refer to like elements throughout unless otherwise noted.

As will be described in greater detail below, in one embodiment, the mount of the present disclosure is used in connection with an architectural-structure covering. In use, the architectural-structure covering is used in relation to an architectural structure, which, without limitation, may be an opening such as a window, doorway, archway, a portion of a wall, or the like. It will be appreciated that references to an architectural opening/structure are made for convenience, and without intent to limit the present disclosure to a particular structure.

As will be described in greater detail herein, in use, the mount may interconnect the valance to the headrail of an architectural-structure covering so that the valance can move (e.g., pivot) with respect to the headrail. In one embodiment, as will be described, the valance is permitted to move or pivot away from the headrail during use. In this manner, as the covering of the architectural-structure covering is retracted, bunching of the covering adjacent to the headrail may cause the valance to move or pivot away from the headrail, thus minimizing or eliminating any resulting adverse effects to the covering, valance, etc.

In one embodiment, the mount may include a first portion, a second portion, and an intermediate portion positioned between the first and second portions, the intermediate portion having increased movability and/or flexibility relative to the first and second portions for enabling the first and second portions to move relative to each other. In one example embodiment, the first and second portions are manufactured from a first material having a first rigidity (e.g., a plastic or the like) and the intermediate portion is manufactured from a second material having a second rigidity (e.g., an elastomer or rubber or the like) where the first rigidity is greater than the second rigidity. Additionally, and/or alternatively, the mount (e.g., the first portion, the second portion, and the intermediate portion) may be integrally made. The intermediate portion includes a hinge, which in one non-limiting example embodiment is a living hinge, so that the first portion can move with respect to the second portion. In use, the first portion is operatively associated with the headrail while the second portion is operatively associated with the valance. In one non-limiting example embodiment, the first portion is adapted and configured to be received within a longitudinal groove formed in the headrail. Alternatively, in another non-limiting example embodiment, the first portion may include a planar surface for coupling to a planar surface of the headrail. Similarly, the second portion may include a planar surface for coupling to a planar surface of the valance.

Also disclosed is an architectural-structure covering comprising a headrail, a covering movable between a retracted position and an extended position, a valance operably associated with the headrail, and one or more mounts for movably coupling the valance to the headrail so that when the covering is in the retracted position, contact between the covering and the valance causes the valance to pivot away from the headrail. Each of the one or more mounts includes a first portion for operatively coupling to the headrail, a second portion for operatively coupling to the valance, and an intermediate portion positioned between the first and second portions, the intermediate portion having increased movability and/or flexibility relative to the first and second portions for enabling said first and second portions to move relative to each other. In some non-limiting example embodiments, the first and second portions are manufactured from a first material having a first rigidity (e.g., a plastic or the like) and the intermediate portion is manufactured from a second material having a second rigidity (e.g., an elastomer or rubber or the like) where the first rigidity is greater than the second rigidity. Additionally, and/or alternatively, the first portion, the second portion, and the intermediate portion are integrally made. The intermediate portion may include a hinge, such as a living hinge, so that the first and second portions are movable relative to each other.

A method for enabling a valance to move relative to a headrail of an architectural-structure covering is also disclosed. The method comprises coupling the valance to the headrail via one or more mounts, each of the one or more mounts being adapted and configured so that the valance is movable relative to the headrail, moving a covering portion of the architectural-structure covering from an extended position to a retracted position, contacting, via the covering portion, a valance associated with a headrail of the architectural-structure covering, and moving at least a portion of the valance away from the headrail.

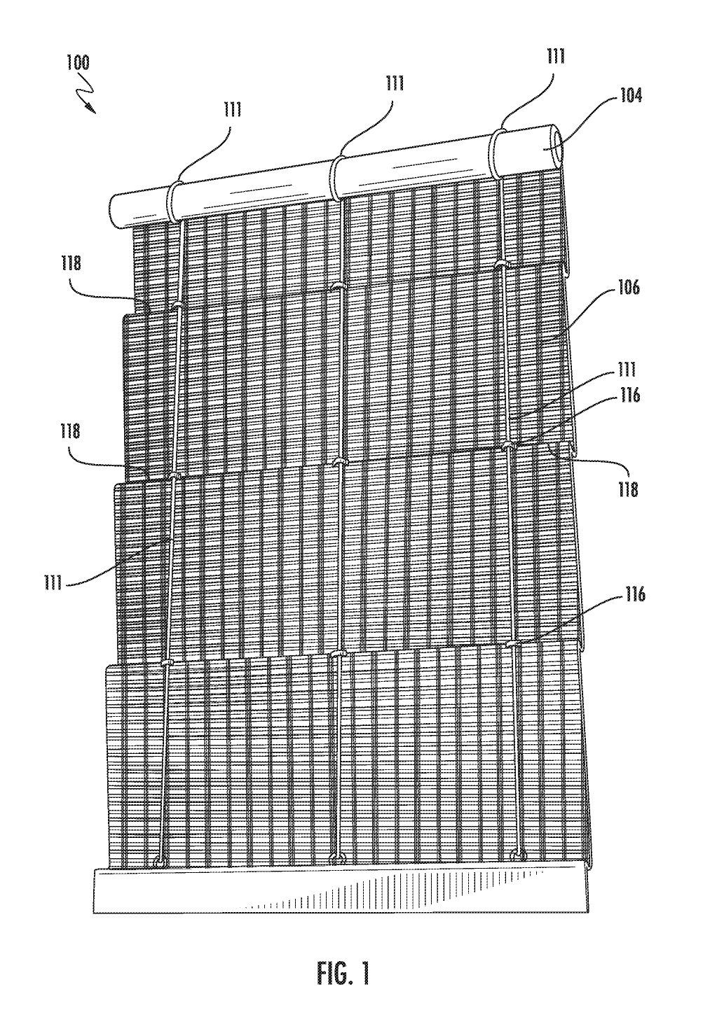

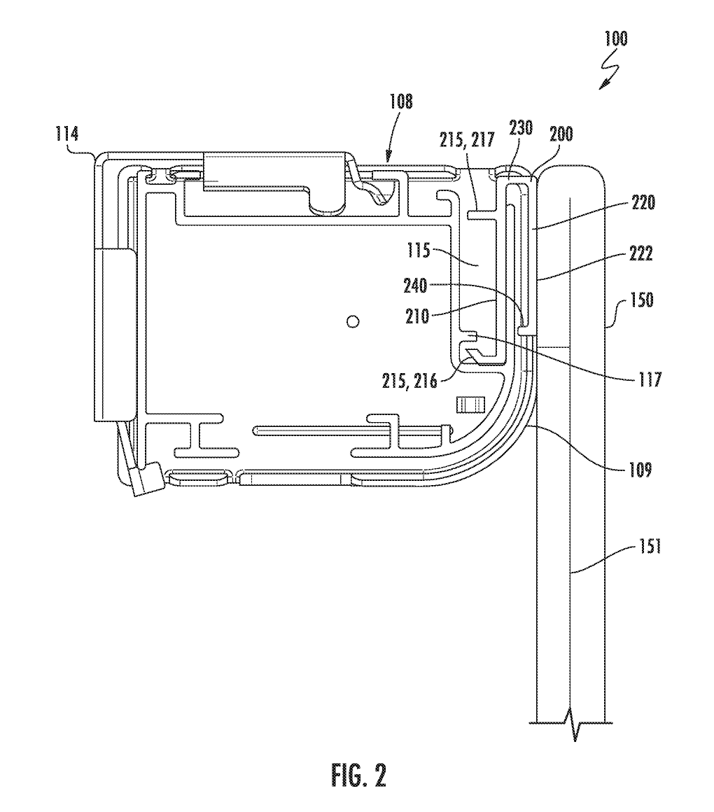

Referring to FIG. 1, an example of an embodiment of an architectural-structure covering 100 that may be used in accordance with the present disclosure is illustrated. The architectural-structure covering 100 may include a headrail 108 (FIG. 2), which in the illustrated embodiment is a housing having opposed end caps joined by front, back, and top sides to form an open bottom enclosure. The headrail 108 may also include attachments or brackets 114 (FIG. 2) for coupling the headrail 108 to a structure above, or at the top of, an architectural opening, such as a wall, via mechanical fasteners such as screws, bolts, or the like. Although a particular example of an architectural-structure covering 100 and a headrail 108 is shown, many different types and styles of architectural-structure coverings and headrails exist and could be employed in place of the examples illustrated. As such, the present disclosure should not be limited to any particular type of architectural-structure covering and/or headrail.

In the example illustrated in FIG. 1, the architectural-structure covering 100 includes a covering 106. As illustrated, the covering 106 may be in the form of a stacked or tiered covering such as, for example, a Roman shade made from an architectural material such as a woven wood or the like. It will be appreciated this is an example, and that in other embodiments, the covering 106 may be in the form of, for example, a flexible material having an upper edge and a lower, free edge, the lower edge being movable towards the upper edge to retract the covering, and movable away from the upper edge to extend the covering. It will further be appreciated that other covering types and attaching arrangements are also within the scope of the present disclosure. The illustrated covering 106 is movable between a retracted position and an extended position (illustratively, the position shown in FIG. 1).

The illustrated architectural-structure covering 100 includes a control mechanism, which includes a plurality of lift cords 111 that extend from a top of the covering 100 to a hem or a bottom rail of the architectural-structure covering 100. In the illustrated embodiment, the lift cords 111 are slidingly connected to the covering 106 at intervals along a length of the covering 106. For instance, the lift cords 111 extend through rings connected at intervals along a vertical length of the covering 106, often in conjunction with horizontally placed battens or dowels 118 (e.g., the battens or dowels 118 facilitating folding or forming of folds or pleats). In one embodiment, the lift cords 111 are wrappable around a rotatable member 104 so that rotation of the rotatable member 104 causes the lift cords 111 to wrap about the rotatable member 104. This causes the covering 106 to gather and fold, for example, at the sliding connections 116 between the lift cords 111 and the covering 106 as the lift cords 111 are wrapped about the rotatable member 104, and the covering 106 is raised such that the covering 106 hangs in a plurality of folded pleats having a desired drop length. Although not shown, a drive mechanism can be provided to move the covering 106 between the extended and retracted positions. The drive mechanism can take any appropriate form (e.g., a clutch, a gear, a motor, a drive train, and/or a gear train, etc.) and can include any type of controls (e.g., continuous loop, raise/lower cord(s), chains, ropes, a motor, etc.). It should be understood that the details of the architectural-structure covering 100 are merely examples and that the present disclosure should not be so limited unless expressly claimed. For example, in one embodiment, it is envisioned that instead of using a rotatable member 104, the architectural-structure covering 100 may incorporate cord spools, pulleys, or the like, as would be readily appreciated by one of ordinary skill in the art.

As previously discussed, in use, the covering 106 may become bulky because of bunching up when the covering 106 is retracted. As a result, the covering 106 may contact a valance 150 (FIG. 2) positioned at the upper end of the architectural-structure covering 100, pushing the valance 150 outwards (e.g., causing the valance to bend) away from the architectural-structure covering 100, which may adversely affect the valance and/or covering (e.g., may cause unwanted creases in the covering) and/or aesthetics thereof.

Referring to FIG. 1, for the sake of convenience and clarity, terms such as “front,” “rear,” “top,” “bottom,” “up,” “down,” “vertical,” “horizontal”, “inner,” and “outer” may be used herein to describe the relative placement and orientation of various components and portions of the architectural-structure covering 100, each with respect to the geometry and orientation of the architectural-structure covering 100 as they appear in FIG. 1. Said terminology is intended to be non-limiting and is used herein merely to describe relationship between various components as illustrated in FIG. 1.

Referring now to the example embodiment illustrated in FIG. 2, the headrail 108 includes or is associated with the valance 150. In use, the valance 150 can be manufactured from any suitable material such as, for example, any type of fabric. In one embodiment, the valance 150 may be manufactured from the same type of material used to manufacture the covering 106, although such commonality is not necessary. In addition, in one embodiment, the valance 150 includes a stiffening member 151 such as, for example, cardboard or the like, to stiffen the valance 150 to provide an improved aesthetic finish. In one embodiment, the stiffening member 151 extends a full height of the valance 150. In use, in one embodiment, the valance 150 is coupled to the headrail 108, for example, a front surface 109 of the headrail 108 by any suitable mechanism such as, for example, mechanical fasteners, staples, adhesive, or the like.

In accordance with one example embodiment of the present disclosure, the valance 150 is movably coupled to the headrail 108. That is, in one embodiment, the valance 150 is pivotably coupled to the headrail 108, for example the front surface 109 of the headrail 108, so that, in use, the valance 150 can move or pivot away from the front surface 109 of the headrail 108 so that the valance 150 can move (e.g., pivot) with respect to the headrail 108 as a result of and/or upon contact with the covering 106 when the covering 106 is being moved towards the retracted position. That is, by movably (e.g., pivotably) coupling the valance 150 to the front surface 109 of the headrail 108, during retraction of the covering 106 the valance 150 can move or pivot outwards away from the headrail 108 thus preventing the covering 106 and/or valance 150 from becoming adversely affected. In use, incorporation of a movable (e.g., pivotable) valance is particularly beneficial for use with a stacked or tiered covering such as, for example, a Roman shade made from an architectural material such as a woven wood, as these kinds of covering are particularly susceptible to bunching when retracted.

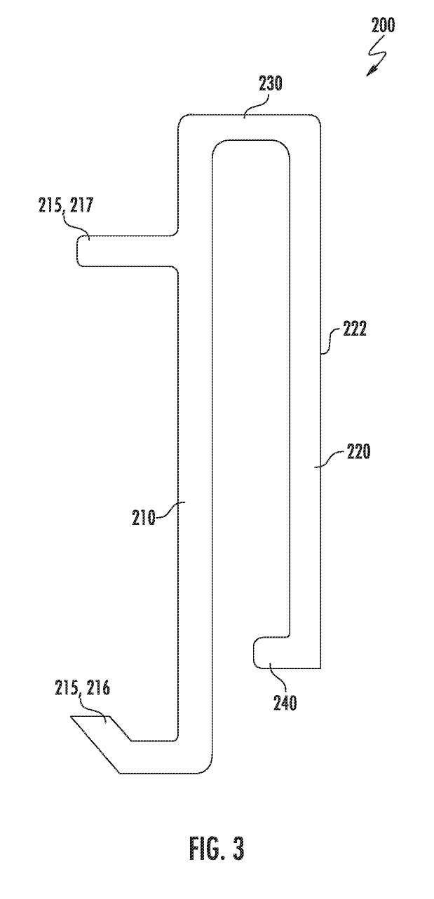

Referring to the illustrated embodiment in FIGS. 2 and 3, the valance 150 is coupled to the headrail 108 via a mount 200 positioned along a longitudinal length of the headrail 108. In one embodiment, the mount 200 may be a single mount that extends an entire or full length of the headrail 108. Alternatively, the mount 200 may be in the form of a clip or the like with a plurality of clips being spaced along the longitudinal length of the headrail 108. As illustrated, the mount 200 may include a first area, section, leg or portion (used interchangeably herein without the intent to limit) 210, a second portion 220, and an intermediate portion 230 located between the first and second portions 210, 220. In use, the intermediate portion 230 is adapted and configured to enable the first portion 210 to move with respect to the second portion 220. In use, the first portion 210 is operatively associated with the headrail 108. For example, as shown, the first portion 210 is adapted and configured to be received within a longitudinal groove 115 formed in the headrail 108. The first portion 210 may include one or more projections 215 for interacting with the longitudinal groove 115 formed in the headrail 108 (although as previously mentioned, the present disclosure is not limited to any particular headrail having any particular structure). As illustrated, the first portion 210 may include a first projection 216 formed, for example, at a lower end of the first portion 210. In use, when properly positioned within the longitudinal groove 115 of the headrail 108, the first projection 216 contacts or interacts with a projection 117 formed in the longitudinal groove 115 of the headrail 108. In this manner, the mount 200 is inhibited or prevented from moving out of the headrail 108 (e.g., moving vertically out in an embodiment in which the mount 200 is positioned within the headrail 108 by sliding the mount 200 into the longitudinal groove 115 formed in the headrail 108 from an end of the headrail 108). As illustrated, the first portion 210 may also include a second projection 217 formed, for example, at an upper end of the first portion 210. The second projection 217 extends substantially perpendicular from the first portion 210 for contacting a surface of the headrail 108. In this manner, movement of the mount 200 may be controlled during pivoting movement of the valance 150 (e.g., second projection 217 prevents over-rotation of the valance 150 relative to the headrail 108). Alternatively, the first portion 210 may be coupled to the headrail 108 by any suitable mechanism such as, for example, staples, mechanical fasteners, adhesive, etc., as will be described and illustrated in greater detail below.

In the illustrated embodiment of FIGS. 2 and 3, the second portion 220 is operatively associated with the valance 150. For example, as shown, the second portion 220 includes a planar surface 222 for coupling to the valance 150 by any suitable mechanism such as, for example, staples, mechanical fasteners, adhesive, etc. The intermediate portion 230 is operatively associated with the first and second portions 210, 220. In addition, the intermediate portion 230 is adapted and configured to enable the first and second portions 210, 220 to move relative to each other so that, in use, the valance 150 can move relative to the headrail 108. For example, the intermediate portion 230 may be in the form of a hinge so that the first and second portions 210, 220 can pivot relative to each other.

As illustrated in the embodiment of FIGS. 2 and 3, the mount 200 is a single piece, although it is envisioned that the mount 200 may be manufactured from multiple separate components operatively coupled together. In use, the intermediate portion 230 may be manufactured by any suitable mechanism for enabling the first and second portions 210, 220 to pivot or flex relative to each other. For example, the intermediate portion 230, or at least a portion thereof, may be manufactured from a different, more flexible material relative to the first and second end portions 210, 220, or at least a portion thereof. For example, in one embodiment, the first and second portions 210, 220, or at least a portion thereof, may be manufactured from a first material while the intermediate portion 230, or at least a portion thereof, may be manufactured from a second material. In this manner, the intermediate portion 230 enables the first and second portions 210, 220 to pivot or flex relative to each other via contact force from the covering 106 when the covering 106 is moved towards the retracted position. Additionally, and/or alternatively, the intermediate portion 230 may, in one non-limiting example embodiment, be in the form of a living hinge so that the first and second portions 210, 220 can pivot or flex relative to each other. By manufacturing the mount 200 with a living hinge, the first and second portions 210, 220 can move or pivot with respect to each other via contact force from the covering 106 when the covering 106 is moved towards the retracted position. In use, a living hinge is generally thinned, cut, or the like to allow rigid pieces or ends to bend along the line of the hinge, although it is envisioned that the intermediate portion could be made flexible by any suitable means now known or hereafter developed. In one embodiment, the intermediate portion 230 is thinned relative to the first and second portions 210, 220 so that it naturally flexes when the first and second portions 210, 220 are moved away from each other.

The intermediate portion 230, if separately formed, may be coupled to the first and second portions 210, 220 by any suitable means now known or hereafter developed including, for example, adhesive, ultrasonic welding, or the like. In one embodiment, the first portion 210, the second portion 220, and the intermediate portion 230 are coextruded.

The mount 200 may be manufactured from any suitable material such as, for example, an elastomer, a rubber, a plastic (e.g., polyvinyl chloride (PVC)), a metal, a wood, or the like. In one embodiment, the first and second portions 210, 220, or at least a portion thereof, may be manufactured from a plastic (e.g., polyvinyl chloride (PVC)) while the intermediate portion 230, or at least a portion thereof, may be manufactured from an elastomer or a rubber. Alternatively, in one embodiment, the mount 200 may be a molded piece of plastic wherein the intermediate portion 230 is slightly thinned relative to the first and second portions 210, 220.

As illustrated in the embodiment of FIGS. 2 and 3, the mount 200 also includes one or more stop members 240 for assisting with proper positioning of the first portion 210 relative to the second portion 220, thus ensuring proper position of the valance 150, for example, in the first or closed position. As illustrated, the stop member 240 may be in the form of an inwardly extending projection formed on the second portion 220 (e.g., extends from an inner surface of the second portion 220 towards the first portion 210), although it is envisioned that the stop member 240 may be provided anywhere on the mount 200, or omitted in its entirety. In use, in the first or closed position, the stop member 240 contacts the headrail 108 such as, for example, the front surface 109 of the headrail 108, so that the valance 150 is properly orientated with respect to the headrail 108.

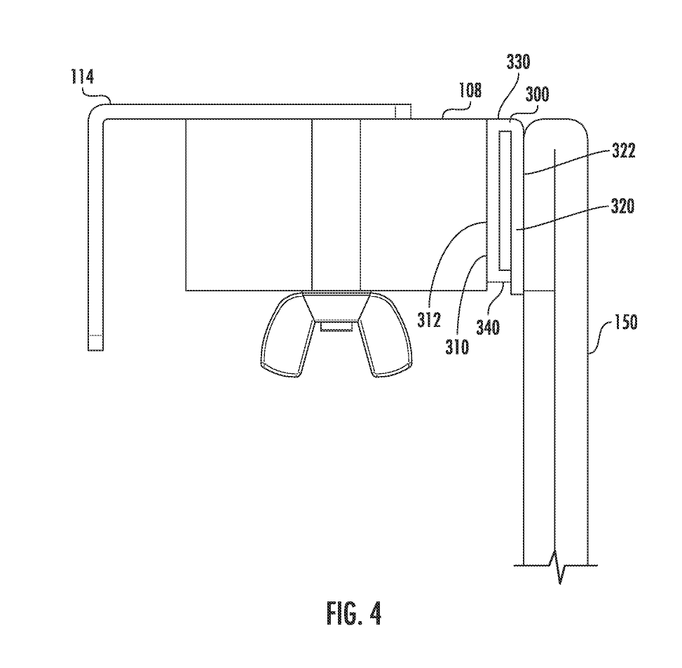

Referring to FIGS. 4-6, in an alternate embodiment, the headrail 108 may be in the form of a block, for example, a metal or wooden block, although as previously mentioned, the headrail 108 may take on any other form and the present disclosure should not be limited to any particular headrail. As illustrated, in this embodiment, the mount 300 includes a first portion 310, a second portion 320, and an intermediate portion 330 located between the first and second portions 310, 320. In use, the intermediate portion 330 is adapted and configured to enable the first portion 310 to move with respect to the second portion 320. In use, the first portion 310 is operatively associated with the headrail 108. For example, as shown, the first portion 310 includes a planar surface 312 for coupling to the headrail 108 by any suitable mechanism such as, for example, staples, mechanical fasteners, adhesive, etc. The second portion 320 is operatively associated with the valance 150. For example, as shown, the second portion 320 includes a planar surface 322 for coupling to the valance 150 (e.g., a rear surface of the valance 150) by any suitable mechanism such as, for example, staples, mechanical fasteners, adhesive, etc. The intermediate portion 330 is operatively associated with the first and second portions 310, 320.

Similar to the previous embodiment, the intermediate portion 330 is adapted and configured to enable the first and second portions 310, 320 to move relative to each other so that, in use, the valance 150 can move relative to the headrail 108. For example, in one non-limiting embodiment, the mount 300 may be coextruded so that the intermediate portion 330, or at least a portion thereof, may be manufactured from a more flexible material relative to the first and second end portions 310, 320, or at least a portion thereof. In one embodiment, the intermediate portion 330 may be in the form of a living hinge so that the first and second portions 310, 320 can pivot relative to each other.

Similar to the previous embodiment, the mount 300 may be manufactured from any suitable material such as, for example, an elastomer, a rubber, a plastic (e.g., polyvinyl chloride (PVC)), a metal, a wood, or the like. In one embodiment, the first and second portions 310, 320, or at least a portion thereof, may be manufactured from a plastic (e.g., polyvinyl chloride (PVC)) while the intermediate portion 330, or at least a portion thereof, may be manufactured from an elastomer or a rubber. Alternatively, in one embodiment, the mount 300 may be a molded piece of plastic wherein the intermediate portion 330 is slightly thinned relative to the first and second portions 310, 320.

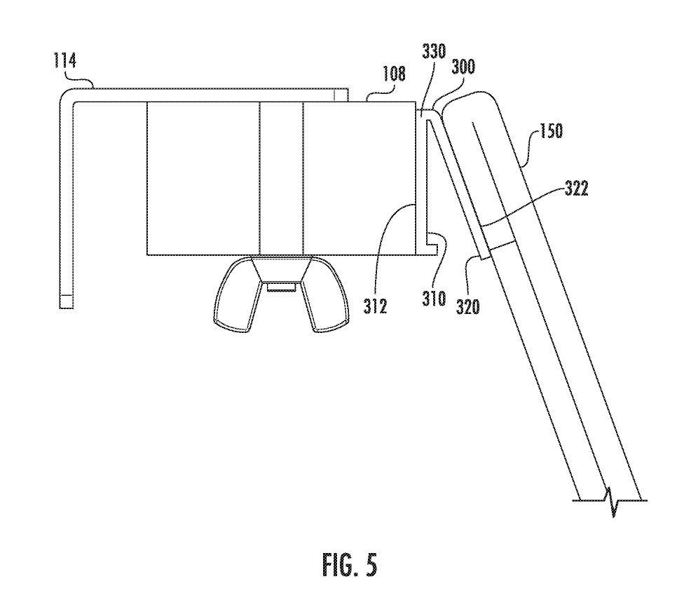

As such, referring to the example embodiment illustrated in FIGS. 4 and 5, the mount 300, and hence the valance 150 that is operatively coupled to the mount 300, is movable (e.g., pivotable) from a first position (FIG. 4), for example, when the covering 106 is in the extended position (e.g., when the covering 106 is not in contact with the valance 150) to a second position (FIG. 5), for example, when the covering 106 is in the retracted position (e.g., when the covering 106 becomes bunched adjacent to the headrail 108 and thus may contact the valance 150). In use, the mount 300, and hence the valance 150 coupled thereto, moves from the first position to the second position via contact with the covering 106 in the retracted position. That is, as the covering 106 is moved from the extended position to the retracted position, the covering 106 may become bulky adjacent to the headrail 108, which in turn may cause the covering 106 to contact the valance 150. In accordance with one aspect of the present disclosure, because of the contact between the valance 150 and the covering 106, the valance 150 moves (e.g., pivots) away from the headrail 108 thus minimizing any adverse effects.

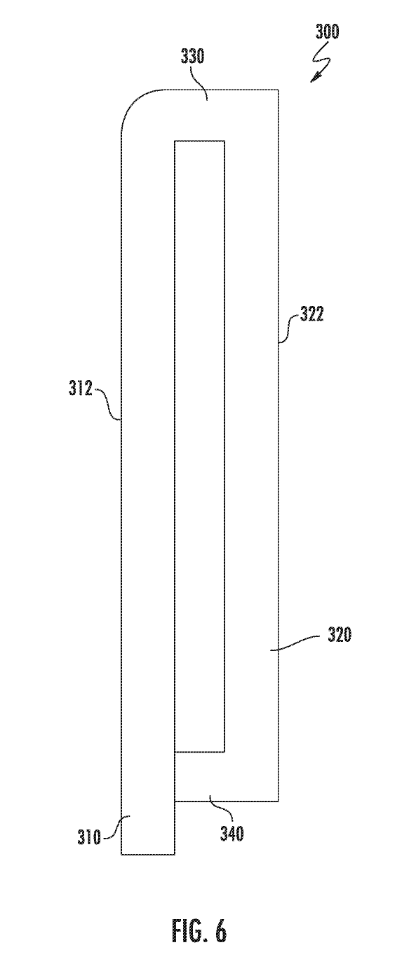

Referring to FIG. 6, similar to the mount 200 previously described, the mount 300 may also include one or more stop members 340 to assist with proper positioning of the first portion 310 relative to the second portion 320, thus ensuring proper position of the valance 150, for example, in the closed position. As illustrated, the stop member 340 is in the form of an inwardly extending projection formed on the first portion 310, although it is envisioned that the stop member 340 may be provided anywhere on the mount 300 including, for example, extending from the second portion 320, or omitted in its entirety. In use, the stop member 340 contacts the second portion 320 of the mount 300 so that the valance 150 is properly orientated with respect to the headrail 108 (e.g., ensuring the mount 300 does not over-rotate, ensuring the first and second portions 310, 320 remain off-set in the closed (non-pivoted) position so the valance 150 is vertically aligned with respect to the headrail 108.

While the present disclosure makes reference to certain embodiments, numerous modifications, alterations, and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

The foregoing description has broad application. It should be appreciated that the concepts disclosed herein may apply to many types of coverings, in addition to the roller-type coverings described and depicted herein. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The phrases “at least one”, “one or more”, and “and/or”, as used herein, are open-ended expressions that are both conjunctive and disjunctive in operation. The terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. All rotational references describe relative movement between the various elements. Identification references (e.g., primary, secondary, first, second, third, fourth, etc.) are not intended to connote importance or priority, but are used to distinguish one feature from another. The drawings are for purposes of illustration only and the dimensions, positions, order and relative to sizes reflected in the drawings attached hereto may vary.

What is claimed:

1. An architectural-structure covering comprising:
a headrail;
a covering movable between a retracted position and an extended position;
a valance operably associated with said headrail; and
one or more mounts for movably coupling said valance to said headrail so that when said covering is in said retracted position contact between said covering and said valance causes said valance to pivot away from said headrail;
wherein each of said one or more mounts includes:
a first portion for operatively coupling to said headrail;
a second portion for operatively coupling to said valance; and
an intermediate portion positioned between said first and second portions, said intermediate portion having increased flexibility relative to the first and second portions for enabling said first and second portions to move relative to each other.

2. The architectural-structure covering of claim 1, wherein said first portion and said second portion are manufactured from a first material having a first rigidity, and said intermediate portion is manufactured from a second material having a second rigidity, said first rigidity being greater than said second rigidity.

3. The architectural-structure covering of claim 2, wherein said first material is a plastic and said second material is a rubber.

4. The architectural-structure covering of claim 1, wherein said first portion, said second portion, and said intermediate portion are integrally made.

5. The architectural-structure covering of claim 1, wherein said intermediate portion includes a living hinge.

6. The architectural-structure covering of claim 1, wherein said one or more mounts is a single mount extending an entire length of said headrail.

7. The architectural-structure covering of claim 1, wherein said one or more mounts is a plurality of mounts spaced along a longitudinal length of said headrail.

8. The architectural-structure covering of claim 1, wherein said first portion is adapted and configured to be received within a groove formed on said headrail.

9. The architectural-structure covering of claim 1, wherein said first portion includes a first planar surface for coupling to a front surface of said headrail.

10. The architectural-structure covering of claim 1, wherein said second portion includes a second planar surface for coupling to a rear surface of said valance.

11. The architectural-structure covering of claim 1, wherein said valance includes a stiffening member to stiffen said valance, said stiffening member extending a full height of said valance.

12. A mount for movably coupling a valance to a headrail of an architectural-structure covering, the mount comprising:
a first portion for operatively coupling to said headrail;
a second portion for operatively coupling to said valance; and
an intermediate portion positioned between said first and second portions, said intermediate portion having increased flexibility relative to the first and second portions for enabling said first and second portions to move relative to each other.

13. The mount of claim 12, wherein said first portion and said second portion are manufactured from a first material having a first rigidity, and said intermediate portion is manufactured from a second material having a second rigidity, said first rigidity being greater than said second rigidity.

14. The mount of claim 13, wherein said first material is a plastic and said second material is a rubber.

15. The mount of claim 12, wherein said first portion, said second portion, and said intermediate portion are integrally made.

16. The mount of claim 12, wherein said intermediate portion includes a living hinge.

17. The mount of claim 12, wherein said first portion includes a first planar surface for coupling to a front surface of said headrail.

18. The mount of claim 12, wherein said second portion includes a second planar surface for coupling to a rear surface of said valance.

19. A method for enabling a valance to move relative to a headrail of an architectural-structure covering, the method comprising:
coupling said valance to said headrail via one or more mounts, each of said one or more mounts including an intermediate portion having increased flexibility relative to first and second portions of said one or more mounts for enabling said first and second portions to move relative to each other so that said valance is movable relative to said headrail;
moving a covering portion of the architectural-structure covering from an extended position to a retractable position;
contacting, via said covering portion, said valance; and
moving at least a portion of said valance away from said headrail.

20. The method of claim 19, wherein moving at least a portion of said valance away from said headrail includes pivotably moving said valance from said headrail as a result of said covering portion contacting said valance.

21. The method of claim 19, further comprising incorporating a stiffening member into said valance, said stiffening member extending a full height of said valance.
